(19) United States
(12) Patent Application Publication
(10) Pub. No.: US 2011/0313837 A1
(43) Pub. Date: Dec. 22, 2011

(54) System And Method For An Advertising, Loyalty And Rewards Program

(76) Inventors: Michael J. Katz, Alpharetta, GA (US); Chad A. Osgood, Alpharetta, GA (US); Lyndon B. Whitley, Woodstock, GA (US); David S. Lewis, Alpharetta, GA (US)

(21) Appl. No.: 13/161,043

(22) Filed: Jun. 15, 2011

Related U.S. Application Data
(60) Provisional application No. 61/354,929, filed on Jun. 15, 2010.

(51) Int. Cl. G06Q 30/00

(52) U.S. Cl. 705/14.27

(57) ABSTRACT

A system includes a server, a member portal in communication with the server, a merchant portal in communication with the server, wherein the server captures data relating to a member and the member's transactions, receives data entered by the member and processes the data to administer an advertising, loyalty and rewards program.

### TECHNICAL FIELD

This application is directed to a technology system and method for a business advertising program which includes loyalty programs and rewards programs.

### BACKGROUND

From a consumer perspective, there is no way of tracking the spend at various restaurants and the offers available at various restaurants. While some restaurants offer loyalty program discounts, i.e., buy 10 sandwiches and receive the 11^{th} sandwich free, consumers are forced to carry a loyalty card for each restaurant patronized. The volume of cards required quickly becomes a disincentive for consumers to take advantage of more than a few offers.

Thus, there is a need for a system and method to provide an effective advertising vehicle for restaurants and other businesses which provide for the tracking of effectiveness of the advertisements while at the same time providing for loyalty and customer rewards.

### SUMMARY

Disclosed herein is a business advertising program which may include loyalty programs, rewards programs, and the like (hereinafter reward system). In summary and in accordance with an embodiment of the disclosure, a restaurant owner may subscribe to a reward system. A consumer may register with the reward system and register a credit or debit card of choice. The user then may select and patronize a restaurant from the reward system and charge the meal to the registered credit or debit card. The restaurant may then pay a sales commission for “delivering” the customer to the restaurant. The sales commission may fund a rebate back to the consumer. The reward system may track rebates and provide a reloadable cash value card with the rebate amount on the card. Additional rebates may accumulate on the same card and may usable by the consumer in any way the consumer chooses. The restaurant owner may offer loyalty programs which are tracked by the reward system. The reward system may offer its own loyalty and rewards program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is an exemplary block diagram representing a general purpose computer system in which aspects of the present invention and/or portions thereof may be incorporated;

FIG. 2 is an exemplary illustration of a merchant portal;

FIG. 3 is an exemplary block diagram of consumer portal features;

FIG. 4 is an exemplary block diagram of reward system search features;

FIG. 5 is an exemplary block diagram of a reward system;

FIG. 6 is an exemplary illustration of remote access to a reward system;

FIG. 7 is an exemplary method of implementing a saturation search;

FIG. 8 is an exemplary illustration of a mobile search results flow;

FIG. 9 is an exemplary method of a transaction using a reward system; and

FIG. 10 is an exemplary method of a transaction using a reward system.

### DETAILED DESCRIPTION OF ILLUSTRATIVE EMBODIMENTS

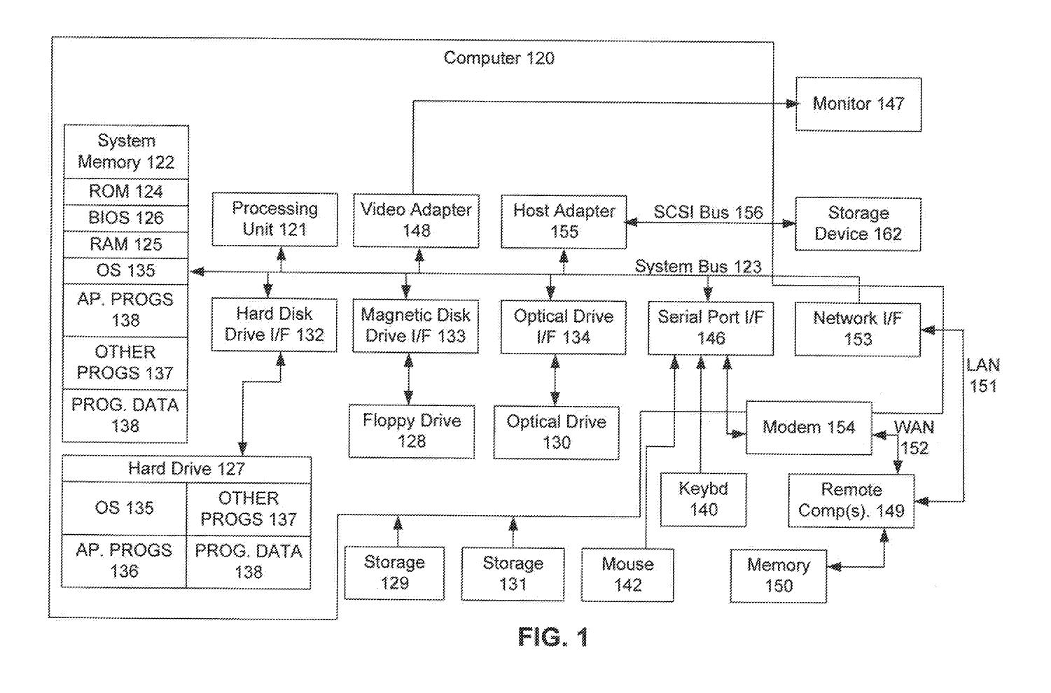

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation, server, or personal computer. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

FIG. 1 is a block diagram representing a general purpose computer system in which aspects of the present invention and/or portions thereof may be incorporated. As shown, the exemplary general purpose computing system includes a computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the computer 120, such as during start-up, is stored in ROM 124.

The computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a computer may include other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The computer 120 may operate in a networked environment using logical connections to one or more remote computers, such as a remote computer 149. The remote computer 149 may be a personal computer, a server, a router, a network PC, a peer device or other common network node, and may include many or all of the elements described above relative to the computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the computer 120 is connected to the LAN 151 through a network interface or adapter 153. When used in a WAN networking environment, the computer 120 may include a modem 154 or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing a communications link between the computers may be used.

Computer 120 may include a variety of computer readable storage media. Computer readable storage media can be any available media that can be accessed by computer 120 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 120. Combinations of any of the above should also be included within the scope of computer readable media that may be used to store source code for implementing the flow charts described in detail below.

In describing embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In general, as used herein, an authenticated user may be described as a member (e.g., merchant member or consumer member), while a consumer or merchant may refer to a authenticated or non-authenticated member. As stated herein, terminology is employed for the sake of clarity; the claimed terminology “consumer,” “merchant,” “consumer member,” “merchant member,” or other terminology in some instances may be understood to perform in a similar manner to accomplish a similar purpose.

A merchant may be an entrepreneur, restaurant owner, and someone that embraces technology. Yet a merchant's time in the restaurant may be focused on operations, quality control and staff issues and thus may have little time to interact with other technologies. The reward system may allow a merchant member to have ready access to critical information needed to run her business. This may mean the ability to extract vital reports on an as-needed basis in a form that can be quickly integrated into existing processes. For example, financial analytics capable of being exported to Excel. The reward system may allow for mobile accessibility to information as well.

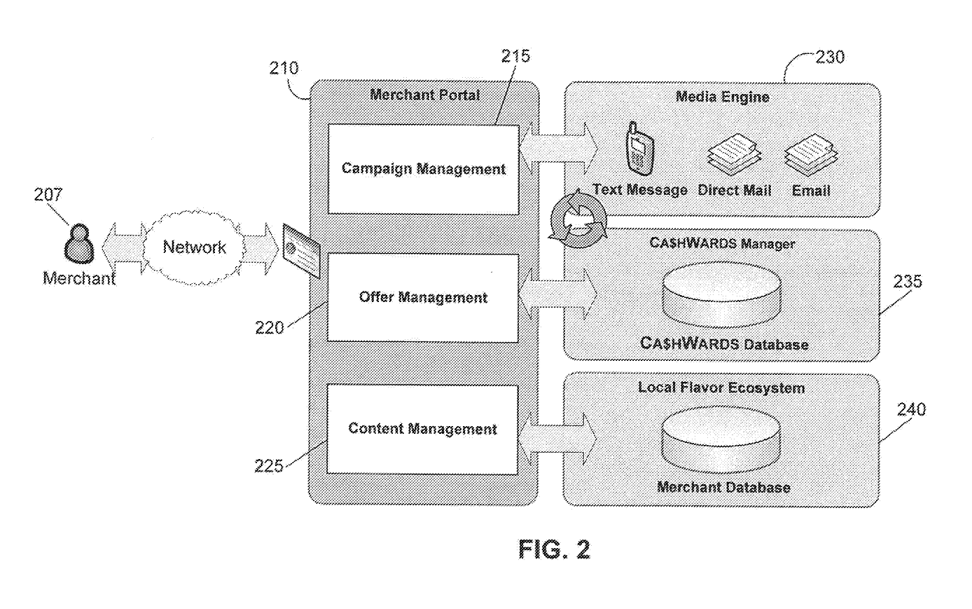

A merchant member may interact with the reward system through a merchant portal. FIG. 2 is an exemplary illustration of a merchant member's 202 interaction with the merchant portal 210 and the subsystems that may be involved in supporting merchant member's 202 activities. Merchant portal 210 may have the features of Campaign Management 215, Offer Management 220 and Content Management 225. Note there may also be a similar portal with administrative access for administrators of the reward system.

Campaign Management 215 may present options for merchant member 202 to launch a promotional campaign for certain offers. This in turn may leverage Media Engine subsystem 230 which may produce and monitor the actual campaign. These campaigns may leverage Media Engine 230 and may allow merchant member 202 to define time-sensitive campaigns to be sent to a particular consumer demographic.

Offer Management 220 may allow merchant member 202 to view her current reward offers, update the offers, monitor the offers, or create new offers. An offer browser may allow the merchant to browse other offers in the reward system to measure success and to reduce the time required to develop a successful offer. For example, a merchant may be able to look view the top ten offers that generate the most consumer traffic of similar restaurants in a geographic area, which may assist the merchant in creating a successful offer. The Cash Rewards Manager subsystem 235 may be responsible for execution and monitoring, allowing time-sensitive offers to be created and then promoted by Media Engine 230. For example, an offer may be limited to 1 per week, 3 per week or some other time-based constraint.

Content Management 225 may enable merchant member 202 to view all content associated with her restaurant. Content Management 225 may allow merchant 202 member to interact with and update the Merchant Database 240 and allow all or some of the reward system participants to see updates. Content may include hours of operation, menus, videos and anything else needed.

Another feature that may be available under a merchant portal is an analytics dashboard (not shown). The analytics dashboard may be available so a merchant member 202 may view analytics at a glance. For example, a chart may display activity by zip code to give the merchant member 202 an indication of where the most consumer activity and response to offers may originate.

A consumer may be a cost-conscious foodie, for example, someone that loves the restaurant experience but may be always looking to achieve the greatest value for her dollar. The reward system may allow her to maximize her food dollars while providing exposure to new restaurants. A consumer member may desire the ability to discover new restaurants in her area or restaurants in an area she'll be visiting while traveling for work.

There may be multiple features and entry points into the consumer portal. A non-authenticated user (e.g., non-member) may be presented with search results upon entering search criteria. (e.g., zip code, restaurant type, cash reward offer amount). An authenticated user (e.g., consumer member) may be directed automatically to the consumer member's most recent search results or to another welcome or home page.

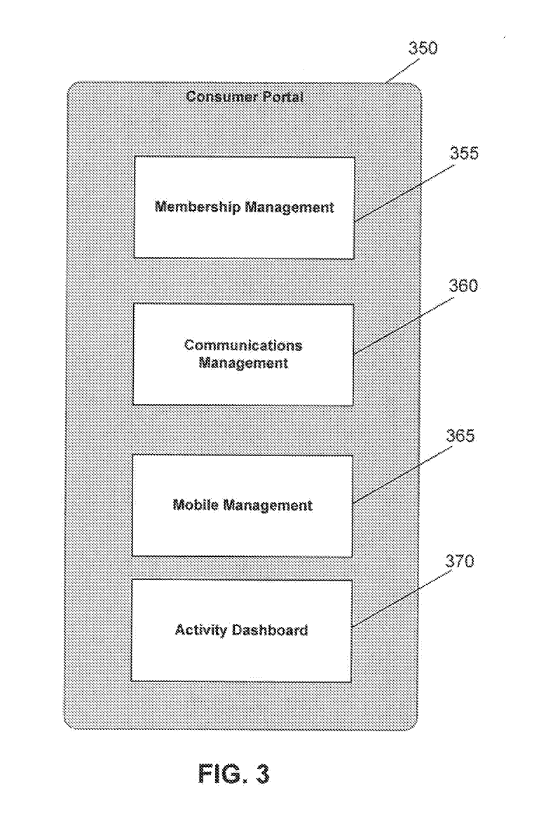

FIG. 3 is an exemplary block diagram of consumer portal features. Consumer Portal 350 may comprise a Membership Management system 355, Communications Management system 360, a Mobile Management system 365, and an Activity Dashboard 370. A consumer may use Member Management system 355 to register for the reward system, update profile information (name, address, email, credit card information, etc.), view dining activity (including dollars spent), and view cash reward account balances.

Communications Management system 360 may give a consumer member control over how the reward system communicates with the consumer member. This may include email, text, social networks, or the like. The consumer may have the ability to choose restaurants of interest and offer notifications, including real-time notifications.

Mobile Management system 365 may give a consumer member the ability to access membership information from a variety of mediums, including online through a web portal, by texting to the reward system, and also through integrated voice response (IVR).

Activity Dashboard system 370 may display the latest cash reward activity, latest restaurant visits and any other metrics that might be deemed of value to the consumer. This may include total cash rewards, total reward system loyalty bonus, total dollars spent, and the balance on a cash reward debit card, among other things. The data may be identified based on a defined date range. Also, the dashboard may show the date a deposit of cash rewards will be made to a cash reward debit card.

With regard to searching, a consumer may be given search results based on search criteria. A screen may display all or some of the restaurants that match the consumer's criteria on a map, list, or the like that displays the location of each restaurant. For each result, sufficient detail about the restaurant may be given to allow the consumer to make a choice. This may include what offer is being given and the name of the restaurant.

The search results screen may allow the consumer to review and modify the search results without taking the consumer away from the page. This may include viewing restaurant details, updating criteria, and choosing restaurants from the displayed map. A consumer may be able to register to become a consumer member and take advantage of the offers by signing up.

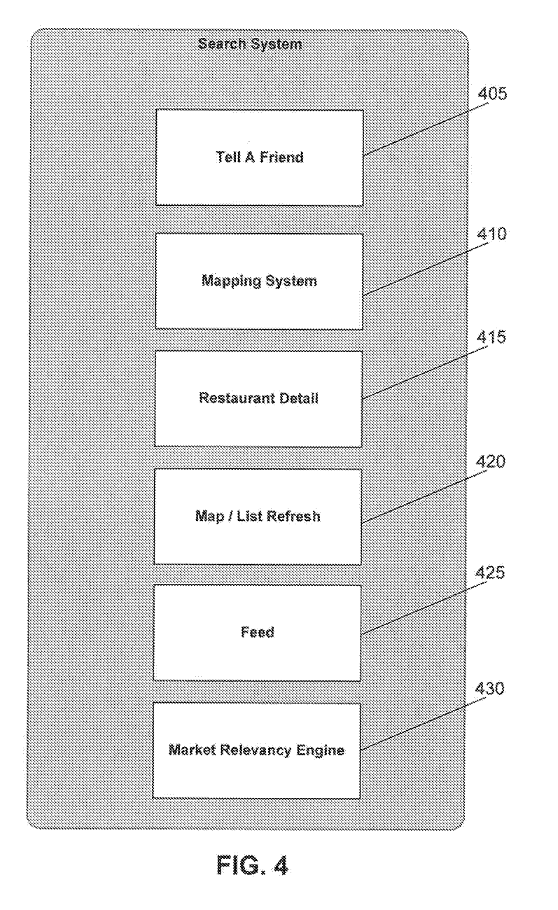

FIG. 4 is an exemplary block diagram of reward system search features. A tell a friend feature 405 may allow a consumer the ability to share a search result via text, e-mail, social media sites (e.g., Twitter™ and Facebook™), and the like.

A mapping feature 410 may display an interactive map based on search criteria from the consumer. The map may be customized to be consistent with a particular theme, including custom location pins and balloon popups.

A restaurant detail feature 415 may display an icon for each search result that the user may click on to view a detail in a modal popup window. This may include a restaurant dining menu, videos, hours of operation, and any other associated detail for a restaurant. The restaurant detail screen may be a subset of the overall detail screen. Also, the time for which a particular offer is available may be displayed.

A Map/Listing Refresh feature 420 may be available. A displayed map or listing may refresh during the time the consumer is viewing the information. For example the listing may refresh and an offer may be displayed that says “expired notification,” or the like. In another embodiment, a consumer may not see offers in another neighborhood, city, or state, because of a restriction to “local” consumers only. As stated herein local may be defined differently and based on different merchant parameters, consumer parameters, and transaction based parameters, among other things.

A feed feature 425 may allow consumers to interact based on location in a new and unique manner. A feed 425 may create a dynamic page that may provide impetus for consumers to return. The feed 425 may display consumer or merchant discussions that occur within a geographic area (e.g., local area). For example, a search based on the location Atlanta, Ga., may display blogging information and other messaging activity regarding the displayed restaurants in Atlanta, Ga. This may include iconography to allow consumers to easily determine what content is being provided. Both consumers and merchants may have the ability to upload pictures and videos in addition to providing microblogging content. For example, a merchant might be able to communicate “New menu out today!” and have that message as part of Alpharetta, Ga. A consumer may communicate “best restaurant for italian,” and have the message as part of a local blog based on search results and/or consumer profiles.

A Marketing Relevancy Engine 430 may continually learn more about a consumer preferences. For example, if a consumer chooses primarily Mexican restaurants that are not chains, the Marketing Relevancy Engine 430 may discern this and present options deemed to be more desirable to the consumer.

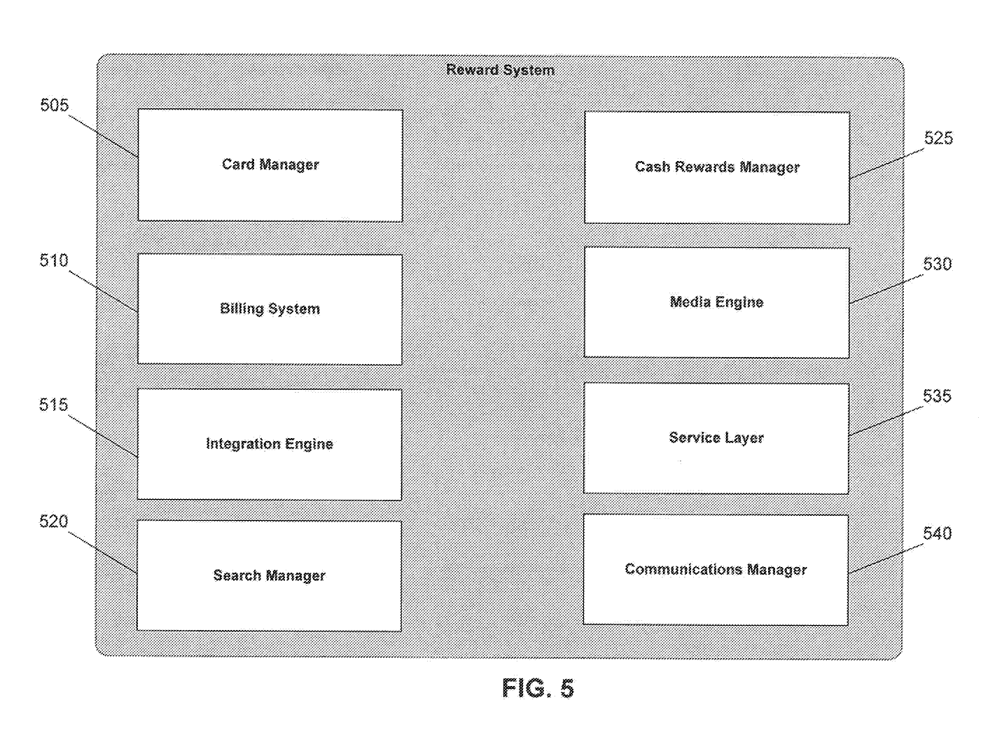

Herein are operating specifications which may refer to the subsystems that may be built to support the reward system. The information presented may give a high-level overview of various parts that may be desired for the reward system. FIG. 5 is an exemplary block diagram of the possible elements that may comprise or interact with the reward system. There may be a card manager 505, a billing system 510, an integration engine 515, a search manager 520, a cash rewards manager 525, a media engine 530, a service layer 535, and a communications manager 540, for example.

Card manager 505 may have responsibilities with regard to the processing and activation of newly issued cash reward debit cards. This may include Integrated Voice Response (IVR), online activation, and automated card fulfillment. Card manager 505 may also involved in the issuance of different forms of cash reward payments to consumers. For example, the cash reward may be delivered by check, ACH to the consumer's bank account or a charity, by mobile payment/mobile wallet, and the like. Billing system 510 may support fee calculation. Fee calculation may include the calculation of a marketing fee paid to the reward system provider against the net of a consumer purchase, after any cash reward deduction, for example. This fee may be merchant-specific and configurable on a per-transaction basis. Billing system 510 may support cash reward processing in which the cash reward amount may be deducted from the merchant member via ACH. There may also be billing reports which may include a detail of the transaction history, including the marketing fee and cash reward deduction. The reports may be emailed, available on demand, or scheduled to be sent automatically.

Integration engine 515 may facilitate the integration of third-parties into the reward system. This may include the import/export of any information necessary for the reward system vendors and customers (e.g., merchants and consumers). For example, there may be transaction processing integration which may integrate the transaction processing data into a reward system database, including qualified transactions. There may be card fulfillment provider integration which may include integration with the provider that automates cash reward debit card fulfillment.

Cash rewards manager 525 may be responsible for applying the necessary rules for qualifying transactions. The cash rewards manager 525 may determine if a consumer member transaction meets the required spend necessary for a cash reward offer. The cash rewards manager 525 may capture and populate the consumer member's profile account. The cash rewards manager may coordinate the loading of cash rewards onto a debit card periodically or aperiodically. The cash rewards manager 525 may track the distribution of awards through the system, including eligibility. The cash awards 525 manager may be flexible enough so that it may enable the creation of offers devised by merchants and bonus programs devised by managers of the reward system. The cash rewards manager 525 may be responsible for applying the business rules for each transaction to see if it qualifies for a cash reward. This may also include the processing of reward system loyalty bonuses.

The cash rewards manager 525 may include an affiliate model feature. The affiliate model may allow affiliates or invitees, consumers, or merchants to associate themselves with another member. This association may allow bonus awards to be given based on the affiliation depending on a number of factors, including total dollars spent or the frequency of visits.

The cash rewards manager 525 may include a program manager feature. The program manager feature may allow merchants and reward system staff, for example, to devise new offers and manage the offer execution. The program manager may be flexible and may be based on a business rules engine so that new programs can be easily created by the merchants and then reviewed before execution. This may include creating a program based on the frequency of visits, total dollar value of a single visit, or any other criteria. Also, frequency-based offers may be necessary so that a merchant may specify a maximum number of times an offer can be used by a consumer member within a certain period of time. The criteria may take the offer management functionality of the merchant portal into account. In addition, the program manager feature may enable the execution of “real-time” cash reward offers and may send them to the Media Engine for promotion. Programs may be based on a scheduled start and end time, including day, hour, and minute.

The cash rewards manager 525 may also include a reward system loyalty feature. The loyalty feature may be a bonus applied to a consumer account based on the amount of cash rewards given in a period of time. For example, loyalty of $250 may mean that the consumer may have to achieve $250 in cash rewards over a defined period of time (e.g., 3 months). If the consumer has achieved $250 in 3 months the consumer member may receive a predefined bonus. This may be managed by the cash rewards manager in addition to the merchant offers.

The media engine 530 may be responsible for leveraging the reward system and its data for the purposes of driving campaign media. This may be for a single email to a consumer member or thousands of emails by a merchant member to specific consumers. Campaigns may include marketing campaigns that will be launched on behalf of the consumer: email, direct mail, text and other mediums. Media engine 530 features may be purchased by the merchant directly. A merchant may choose to purchase a block of 500 emails, for example, as one transaction. A third-party email service provider (ESP) may be leveraged to provide full API access with a merchant portal through which merchant members may update their offers and send marketing campaigns.

The media engine 530 may include a list management feature. List management may provide the ability to choose the contact list (e.g., text or e-mail) to which the media may be sent. The member merchant may have the ability to choose from a choice demographic of customers; for example, the entire list may be chosen or a subset based on some search criteria.

The media engine 530 may include a media management feature. The media management feature may include the ability to decide which media will be used (email, text, direct mail) and the ability to manage the content. Media engine 530 may include a campaign management feature. A campaign may be the combination of a list with the choice of media and messaging. This may include the ability to monitor active campaigns and determine response/conversion rates using reporting and analytics.

The media engine 530 may include a media execution feature. The media execution may refer to the actual processing of the campaign. From a cost-benefit perspective, it may be desirable to leverage a service for actual printing and email distribution. This may mean integrating media execution with another service provider.

The media engine 530 may include a contacts integration feature. The contacts integration feature may include the ability to leverage existing investments a merchant member has with respect to the merchant member's contacts to enhance the use of the media engine. This may include integrating with third-party provider e-mail systems (e.g., Outlook, Gmail™, Yahoo™, LinkedIn™ or any other social network for contacts that can be used). The contacts may then be managed with the list management feature described herein.

The service layer 535 may deal with how a party (e.g., consumer, merchant, or other third-party) may access the reward system services when building the party's own products. It may encompass an application programming interface (API) as well as additional service functionality that is conducive to community-driven applications. This may include exposing functionality as representational state transfer (REST) web services for third-parties to create particular reward system extensions.

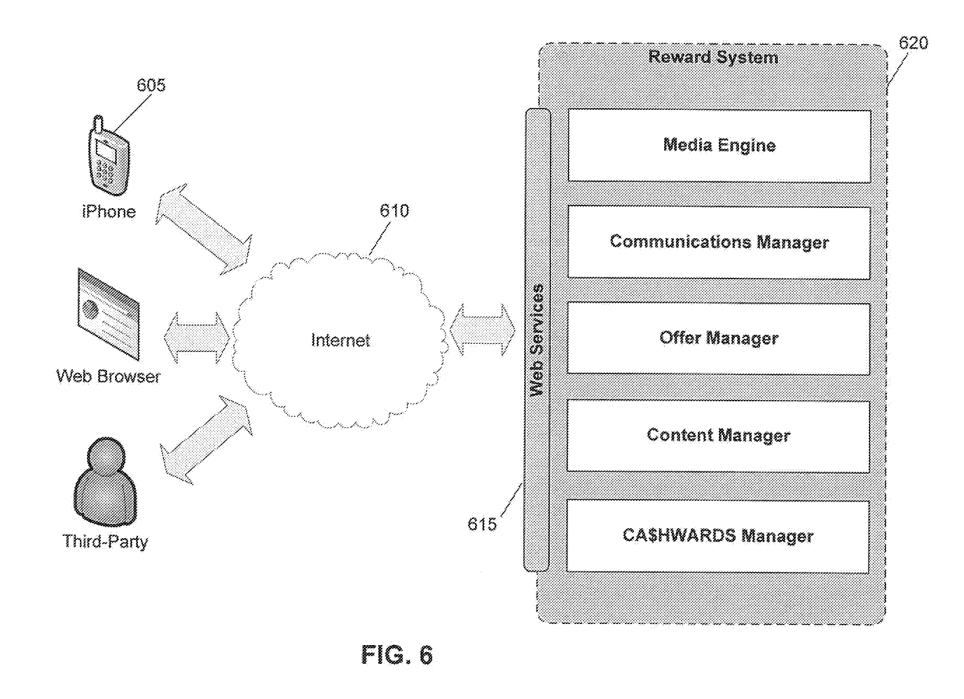

FIG. 6 is an exemplary illustration of how third-parties may access the reward system through the service layer. A third-party may use a mobile device 605 (e.g., a mobile phone) may access the reward system through the internet 610 via a secure HTTPS connection to a web services layer 615. This layer may serve as a façade for all of the desired services in the reward system 620. Web service layer 615 may allow third-parties to use the reward system using web applications, mobile applications, and the like.

The search manager 520 may manage and execute search results. Search manager 520 may be responsible for searching the reward system databases to find relevant search results, but may also assist the user in obtaining the anticipated results as easily as possible. Search manager 520 may include a saturation search feature. The saturation search may allow a consumer to search the reward system databases without having to arbitrarily decide what distance from the consumer's location should be considered. For example, the search engine may search based on the geographic location chosen (e.g., an Atlanta zip code) for affiliated restaurants in a lock step fashion until a saturation point defined by the reward system is achieved.

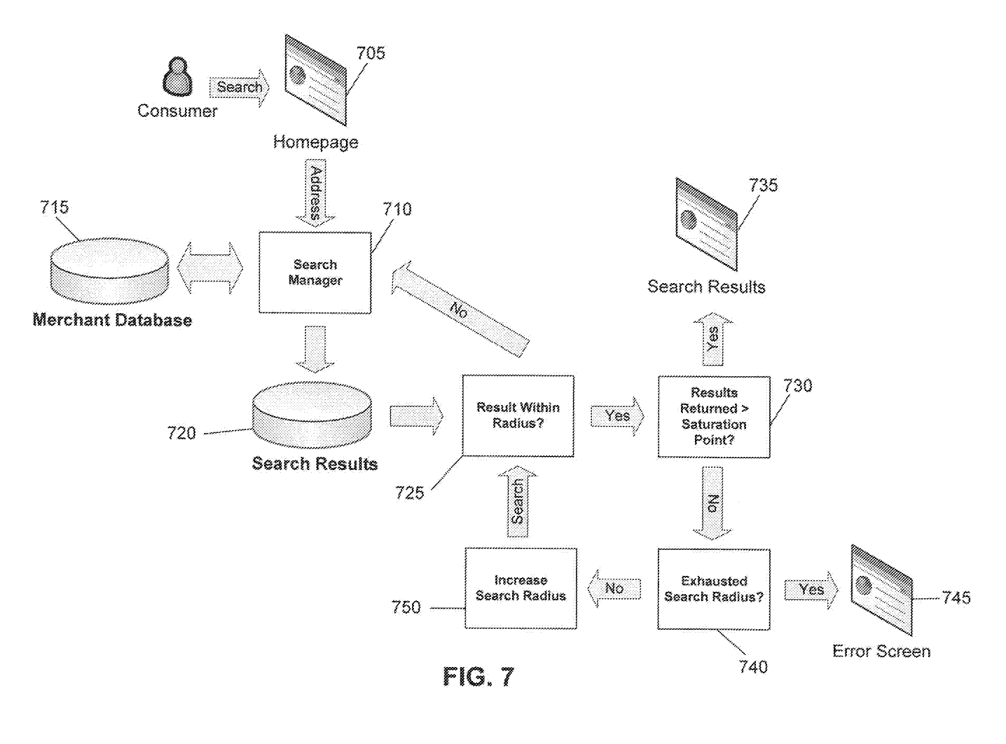

The saturation search may successively search the reward system database until anticipated results are found. FIG. 7 is an exemplary depiction of a saturation search. A consumer may enter a search criteria onto a web browser homepage of the reward system 705. The reward system's databases may be searched based on entered criteria by leveraging the search manager 710. Search manager 710 may then consult with the merchant database 715 and use the geocoded latitude and longitude for identifying candidate restaurants. The search results 720 may then be made available to the rest of the system. A mathematical formula may be used based on the search results. The mathematical formula may help determine whether the given latitude and longitude is within a defined radius 725. If the given latitude and longitude is not within a defined radius, the flow will be returned back to Search manager 710.

The reward system may define a saturation point, a point in which it may be determined that an adequate number of restaurants are available to display to the consumer. For example, this may be 20 or 200 restaurants depending on the circumstances. It may be considered by the reward system that consumers in a dense urban market may have a different sense of “local” than someone in a rural environment. If the returned result meets or exceeds the saturation point 730, the search results are displayed to the consumer 735 and the flow is complete. If it does not meet or exceed the saturation point, a determination may be made whether or not it has exhausted the search radius 740; for example, the reward system may determine that a “local” search should not exceed 30 miles, even for a rural user; in this case, if the current search meets or exceeds that maximum search radius, the search may be considered complete and an Error Screen 745 may be displayed, indicating that no “local” restaurant can be found.

If the search radius is not exhausted, at 750 the search radius may be increased by a set amount; for example, if the radius starts at 5 miles, it might increase by 5 miles until it's exhausted or the saturation point is found. Once the radius is increased, another search may be executed and the flow may resume at 725. A saturation search may also include intelligence about the location to determine what is truly local; for example, in New York City, intelligence may indicate that a much smaller search radius is appropriate versus a more rural setting. This intelligence may be based on demographic information about frequency of spending, population density, restaurant density, or any other information (e.g., census information) that would help create an appropriate sense of what is local for a consumer.

The search manager 520 may include a mobile search results feature. The mobile search results themselves may be an independent concept, something that may be transferred, sent to a third-party, and rendered in multiple visual styles and formats. This separation of data from how it is presented may allow the reward system to create a language used to express “local” in a way that can be leveraged by social media networks, third-party application developers and more.

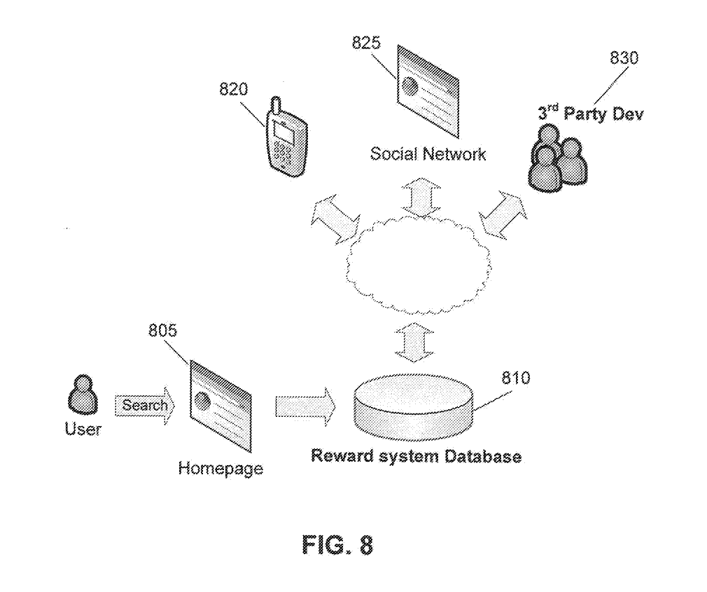

Mobile search results may allow the search results to be shared outside of the reward system boundaries. FIG. 8 is an exemplary illustration of mobile search results flow. A consumer may enter search criteria into the reward system web-based homepage 805, the reward system database 810 may subsequently be made available. The criteria used to searching the reward system databases may be shareable to third party devices via the internet 815. The third party devices may include a mobile phone 820, a social network 825 (or any website), and third-party developers 830, among others.

By making the search results “mobile,” the results may be used for syndication similar to what RSS achieved with blogging. This may give greater utility to the results, and the idea of “What's local for me?” may be exported and reused, allowing consumers to establish local identities with respect to restaurants. For example, a third party website may interact with the reward system database. The reward system database may export to third parties in a standard language what is a particular consumer's (or group of linked consumers') “local.” Consumer X's “local,” for example, is not necessarily just based on geographic location (e.g., via GPS), but may be based on transactions (e.g., frequency, dollar amount, days of the week, hour of the day, interaction/intersection of other linked consumer member transactions). The consumer X's local may be programmed into mobile devices, used in third party apps, and the like to determine the best search results or other “local” date for a consumer which may be based on other local factors as mentioned herein, which may or may not include GPS in the determination.

The search manager 520 may include a search order management feature. Search order management may refer to the ability to control what order the results will appear. This may mean shuffling the results upon each view so as to make a restaurant more likely or less likely displayed more favorably and more frequently than another.

The search manager 520 may include geocoding and reverse geocoding. The ability to geocode (turn an address into a latitude and longitude) and reverse geocode (turn a latitude and longitude into an address) may be made available so that a merchant's address can be plotted on the search map. Geocoding may only be needed when a new restaurant is added or the address changes, because the latitude and longitude may be computed at the time of entry and stored for later use.

The search manager 520 may include a keyword tokenizer. Keyword tokenizers may tokenize keywords so that a reward system search language can be created that allows for more efficient searches expressed by the user; for example, a user might indicate “Italian restaurants near 30308.” These keywords may be tokenized and further processed by the search manager.

The communications manager 540 may be responsible for all communications that are considered external to the reward system. This may include notifications to consumers and merchants, messages as part of a campaign managed by the Media Engine, and system messages to users, among other things. A separate service for the communications manager may be created to handle a high-volume communications and so that additional scalability can be achieved.

The communications manager 540 may include a message queue. A message queue may be established so that messages may be received asynchronously. The asynchronous nature of the messages may allow for greater scalability since there may be no contention on the delivery of the message. The message to be received may be in XML format and include the destination type, such as email, text, or direct mail.

The communications manager 540 may include social media management. This may include check-in features and Tweeting™ about restaurants. Additionally, certain automatic messages may be sent to social media networks (e.g., Facebook™ and Twitter™) about a certain threshold reached. For example, a $100 cash reward might automatically Tweet to an audience about reaching the threshold. This option may be turned on by default and manageable by a consumer, merchant, or other party.

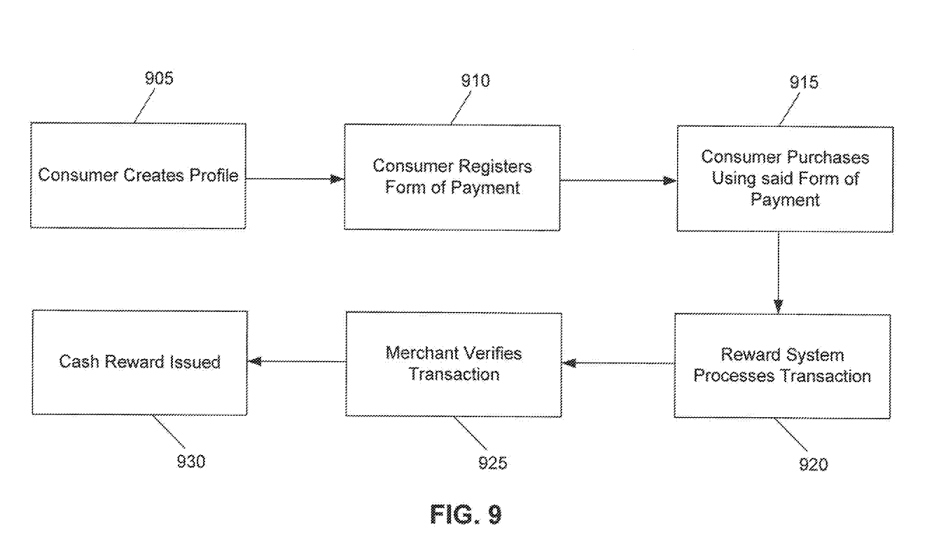

FIG. 9 displays an exemplary transaction flow diagram. At 905 a consumer may create a profile by registering on the reward system website. The consumer may enter an e-mail address, home address, phone number, and other personal information. The consumer may have several payment methods such as credit cards, debit cards, mobile payment/mobile wallet, checks, and the like. For instance, the consumer may choose to register a credit or debit card in his possession. The registered card may be issued by any bank or other organization and does not need to be directly or indirectly affiliated with the owner of the reward system. For example, a consumer, Joe, may own a credit card from a bank called Credit Bank and a debit card from Debit Bank. Joe may register his debit card and credit card without directly alerting the Credit Bank and Debit Bank.

In FIG. 9 at 910, the consumer may use a registered card (or other payment method) at a merchant member restaurant. The registered card may be processed for payment to the restaurant. At 915, transaction matching may occur. All or some of the registered card transactions may be transferred to a reward system database. For example, data regarding transactions of the registered card at member restaurants may be filtered and sent to the reward system database and all other transactions may be deleted. Alternatively all registered card transactions may be sent to the reward system database regardless if it is a transaction at a member restaurant. The transaction data may include the day and time of the transaction, the location of the transaction, and the amount of the transaction, among other things.

In FIG. 9 at 920, the reward system processor may process the registered card transaction data in a myriad of ways. The transaction data may be processed to determine qualifying transactions for a rewards program. For example, a member restaurant may propose a rewards deal for his restaurant that lasts a month for all reward system registrants. The rewards deal may allocate to the registrant $5 for every $120 spent during the entire month. Alternatively, the rewards deal may allocate to the registrant $5 for every daily expenditure of $40 during the month. The reward system my process the transaction to determine whether the transaction qualifies. If the consumer registrant spends only $39 dollars during the entire month then the registrant may not qualify for the $5 rewards deal.

In FIG. 9 at 920, the transaction data may also be processed to give pertinent statistics and other information about consumer transactions at a member restaurant, consumer transactions at several member restaurants in a geographical area, comparisons of consumer transactions at member restaurants in similar metropolitan areas, and the like.

A preliminary qualified transaction may be sent to the member restaurant for verification by a predetermined date. The preliminary qualified transaction may be affirmatively validated at 925 by the member or automatically validated because of the expiration of the time period for dispute/validation.

If the preliminary qualified transaction becomes a qualified transaction, the member restaurant may make an ACH payment to a reward system Bank Account. The ACH payment may include a qualified cash reward to the consumer and/or payment to the reward system administrator for marketing and other services. The reward system Bank Account may send the qualifying cash reward to an issuing processor.

There may be an issuing processor. If a consumer has qualifying cash reward then the issuing processor may load a qualifying reward amount at 930 onto a reloadable credit card, debit card, and the like (e.g., Visa® and/or PayPal™, ACH) and send it to the consumer. The consumer may use the reward card at any establishment that accepts credit cards, debit cards, and the like. In addition, the qualifying cash reward may be sent to the consumer via check. The consumer member may also choose a particular charity to donate the qualifying cash rewards to.

There may be a merchant managed content section of the portal. A merchant may be able to determine what type of cash reward offers the merchant would like to present to the reward system consumer members. For example, the merchant may create an offer that gives a consumer member $5 for every transaction totaling $40 or more. The member merchant may also tailor offers differently to each consumer member based on the amount spent, frequency of visits, for example, by the consumer member at the member merchant's restaurant, restaurants in a geographic region, restaurants in the same dining category as the member merchant, and the like.

In an embodiment, the merchant may also be able to manage how many consumer members take advantage of the offer. In an embodiment, the merchant may be able to limit an offer to a particular number of consumer members (e.g., 36 members) or range (e.g., between 40 and 60 consumer members) during a time period (e.g., a day or a month). The merchant member may be able to set the limit so that when the number of consumer members reaches a particular number (e.g., 36 paying consumer members) then a time period kicks in (e.g., 4 hours after the 36^{th} consumer member has paid). The time limit may be posted on the internet, a mobile device, in the merchants facilities, or a combination thereof, for example.

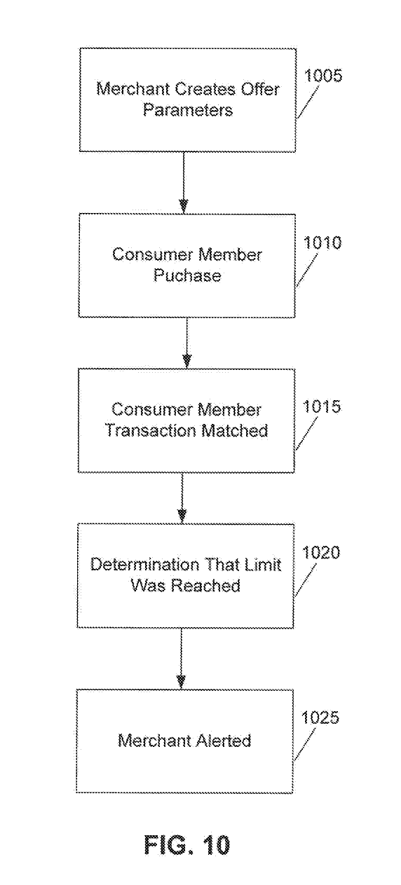

FIG. 10 displays an exemplary transaction flow based on merchant member offer and limit settings. As shown in FIG. 10, at 1005, a merchant member may create a cash reward offer and create a limit of consumer members. The limit may include any consumer member that purchases any amount at the restaurant or it may just include the members who actually qualified for the offer (e.g., a qualifying offer of a $40 purchase and $5 cash back). At 1010 the consumer member may make a purchase from the member merchant. At 1015 the transaction may be matched with the member merchant. At 1020, a determination may be made regarding whether the merchant configured limit is reached. At 1025 the merchant may be alerted and may display the limit reached alert electronically in the merchant's establishment, if desired. For example, the following may be posted on TVs in the merchant establishment: “John is the last member to qualify for the $5 for $40 offer”. The limit reached alert, for example, may also be sent immediately to a consumer member via the consumer member's mobile device. Alternatively, the limit reach alert may be delayed and only sent when the consumer member is at the GPS location of the restaurant for a certain period of time. The immediacy or delay period of the alerts to consumer members may be based on level of participation in the rewards program, subscription fees, and the like.

A merchant member may be able to direct local customer members to the merchant member's restaurant. Local may be explicitly defined by a consumer member or merchant (e.g., 5 miles from an address). The reward system may use the data intelligence that it has collected or analyzed in view of the member consumer's (or merchants when applicable) search patterns, purchase patterns, and other consumer information, such as opt-in profiles, to define a true “one-to-one local” experience. Thus what is “local” for one consumer may not be “local” for another consumer. For example, based on data related to consumer A, “local” may be defined as a 30 mile radius for consumer A, while “local” may be defined as a 5 mile radius for consumer B based on data related to consumer B.

An example of a local transaction may be illustrated by a consumer member X who has some pattern of traveling along a particular path to and from work. The path may be a 15 mile stretch. Thus, it may be determined that local for consumer X is any restaurant within a 0.25 miles of the 15 mile path consumer X takes during particular days. In addition, consumer X may use a mobile device to interact with the reward system. The mobile device may record the speed of consumer X during consumer X's anticipated path. It may be determined based on the slow speed of the mobile device (or other consumer X and/or merchant member preferences) that a particular merchant members are “local” restaurants and consumer X may receive alerts regarding the local member's offers. The offer may be sent to consumer X via e-mail, text, placed on a website, or some other alert. The offer may be sent immediately to consumer X, based on GPS coordinates of the mobile device.

Although a reward system and other systems and methods have been described in connection with the exemplary embodiments of the various figures, it is to be understood that other similar embodiments may be used or modifications and additions may be made to the described embodiments without deviating from the embodiments. Figures may not be drawn to scale and may be viewed in conjunction with the detailed description. Although features and elements are described above in particular combinations, one of ordinary skill in the art will appreciate that each feature or element can be used alone or in any combination with the other features and elements. For instance, the methods and systems herein may be used for and between consumer retail establishments, business entities, government entities, and the like. Therefore, the reward system and other related elements as described herein should not be limited to any single embodiment, but rather should be construed in breadth and scope in accordance with the appended claims.

What is claimed:

1. A reward system comprising:
a consumer portal;
a merchant portal, and
a server in communication with the merchant portal and consumer portal, the server configured to:
receive consumer transaction data,
receive consumer location data,
receive search criteria,
determine a local merchant based on the received consumer transaction data, consumer location data, and search criteria, and
transmit the local merchant determination to the consumer.

2. The reward system of claim 1, wherein the merchant portal comprises:
a media engine component that manages messaging options for a merchant to launch a campaign regarding an offer.

3. The reward system of claim 1, wherein the merchant portal comprises
a cash reward manager component that executes and monitors cash offers based on the merchant parameters.

4. The reward system of claim 1, further comprising an administrative portal.

5. The reward system of claim 1, further comprising a search component.

6. The reward system of claim 5, wherein the search component further comprises a feed component.

7. The reward system of claim 5, wherein the search component further comprises a market relevancy engine.

8. The reward system of claim 1, wherein the consumer portal further comprises an activity dashboard.

9. The reward system of claim 1, further comprising a standard local search component.

10. The reward system of claim 1, further comprising a card manager component.

11. A method comprising:
receiving consumer transaction data;
receiving consumer location data;
receiving search criteria;
determining a local merchant based on the received consumer transaction data, consumer location data, and search criteria; and
transmitting the local merchant determination to a first consumer.

12. The method of claim 11, further comprising:
capturing transaction data of the first consumer based on a registered payment method of the first consumer; and
providing a cash reward to the first consumer based on the first consumer transaction.

13. The method of claim 11, further comprising:
creating a cash reward offer; and
transmitting the cash reward offer to the first consumer based on the local merchant determination.

14. The method of claim 13, wherein the cash reward offer is limited to a number of cash reward qualified transactions.

15. The method of claim 14, wherein the cash reward offer is further limited by date.

16. A machine-readable storage device comprising computer executable instructions for performing a method of promoting a business, the computer executable instructions comprising instructions for:
receiving consumer transaction data;
receiving consumer location data;
receiving search criteria;
determining a local merchant based on the received consumer transaction data, consumer location data, and search criteria; and
transmitting the local merchant determination to the consumer.

17. The machine-readable storage device of claim 16, further comprising:
capturing transaction data of the first consumer based on a registered payment method of the first consumer; and
providing a cash reward to the first consumer based on the first consumer transaction.

18. The machine-readable storage device of claim 16, further comprising:
creating a cash reward offer; and
transmitting the cash reward offer to the first consumer based on the local merchant determination.

19. The machine-readable storage device of claim 18, wherein the cash reward offer is limited to a number of cash reward qualified transactions.

20. The machine-readable storage device of claim 20, wherein the cash reward offer is further limited by date.
